(19) United States
(12) Patent Application Publication
(10) Pub. No.: US 2010/0106297 A1
(43) Pub. Date: Apr. 29, 2010

(54) WORKPIECE DETECTING SYSTEM, PICKING APPARATUS, PICKING METHOD, AND TRANSPORT SYSTEM

(75) Inventors: Mitsuhiro INAZUMI, Shiojiri (JP); Takashi NAGATE, Shimosuwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/578,807

(22) Filed: Oct. 14, 2009

(30) Foreign Application Priority Data
Oct. 27, 2008 (JP) 2008-275248

(51) Int. Cl. G06F 19/00; G01S 15/00

(52) U.S. Cl. 700/245; 367/99

(57) ABSTRACT

A workpiece detection system includes: a plurality of transmitters disposed on a workpiece, each transmitter transmitting a first signal; three or more receivers receiving the first signal transmitted from the transmitter; and a position calculator detecting a location of the transmitter based on the first signal received by each of the receivers. The position calculator detects a posture of the workpiece from information on the detected locations of the plurality of transmitters.

### BACKGROUND

1. Technical Field

The present invention relates to a workpiece detecting system, a picking apparatus, a picking method, and a transfer system, and in particular to a system for detecting a posture of a workpiece.

2. Related Art

Robots are used in steps of assembling and classifying parts. JP-A-2004-1122 as a first related art example discloses an apparatus for detecting the position and posture of a workpiece moving on a conveyer and grabbing the workpiece with a robot. According to this apparatus, a stereo camera is used to detect the posture of the workpiece and a distance between the workpiece and the stereo camera. The workpiece is picked up by controlling the robot.

JP-A-6-222130 as a second related art example discloses a method for measuring the position of a sound source using ultrasonic waves. According to this method, four receiving units receive the ultrasonic waves sent from one ultrasonic wave source. Then, using differences in time for receiving the waves among the four receiving units, the relative position of the ultrasonic wave source to the four receiving units is calculated. JP-A-6-222130 also discloses another method in which three receiving units are used to calculate the relative position of the ultrasonic wave source to the three receiving units.

There is a method in which a camera picks up an image of the workpiece, and the picked-up image is used to analyze the position and posture of the workpiece. This method requires time to analyze the image and to extract the feature points of the workpiece. In case of using a stereo camera, twice as much time is required since two images are analyzed. Calculating the distances between feature points of the workpiece using two images also takes time. Therefore, an apparatus for detecting the posture of the workpiece in shorter time has been desired.

### SUMMARY

The present invention is to solve at least some of the problems mentioned above and may be implemented as in the following aspects.

According to a first aspect of the invention, a workpiece detection system includes: a plurality of transmitters disposed on a workpiece, each transmitter transmitting a first signal; three or more receivers receiving the first signal transmitted from the transmitter; and a position calculator detecting a location of the transmitter based on the first signal received by each of the receivers, in that the position calculator detects a posture of the workpiece from information on the detected locations of the plurality of transmitters.

In this case, three or more receivers receive the signal (first signal) transmitted from each transmitter. The longer the distance between the transmitter and each receiver, the longer the time between transmitting and receiving of the signal. The difference in distance between the transmitter and the receiver is calculated by multiplying propagation velocity and arrival time of the signal. Then, relative position of the transmitter to the receiver is calculated using a triangulation method.

Because the workpiece has the plurality of transmitters disposed thereon, the posture of the workpiece may be detected by detecting the locations of the transmitters. A well-known method for detecting the location and posture of the workpiece is a method in which an imaging device picks up an image and an image processor analyzes the picked up image. This method requires much time for analysis since the amount of information is large. According to the system of the first aspect, however, the location of the transmitter may be detected from less information compared to the method using the image processor, and therefore the position calculator may detect the posture of the workpiece by in a shorter time.

In the workpiece detection system, it is preferable that there be a plurality of types of workpieces and a distance between the transmitters provided to the workpieces be different for each type of the workpiece.

In this case, by detecting the distance between the plurality of transmitters disposed on the workpieces, the type of the workpiece may be recognized.

It is preferable that the workpiece detection system further include an attribute storing unit storing a relationship between the distance between the transmitters and the workpiece, in that the position calculator detects attribute information of the workpiece using data of the distance between the transmitters.

In this case, the attribute information of the workpiece may be confirmed by the position calculator using the attribute information of the workpiece stored in the attribute storing unit.

In the workpiece detection system, it is preferable that the transmitter be an ultrasonic wave tag that transmits ultrasonic waves, and that the receiver receive the ultrasonic waves.

In this case, the distance between the transmitter and the receiver is measured using ultrasonic waves. The ultrasonic waves propagate more slowly than electromagnetic waves such as light or radio waves. Therefore, the propagation time of the ultrasonic waves in response to the propagation distance is longer than that of the electromagnetic waves. As a result, compared to when using the electromagnetic waves, it may be easier to measure the propagation time when using the ultrasonic waves.

In the workpiece detection system, it is preferable that the plurality of transmitters be disposed such that the transmitters transmit the signals in different directions.

In this case, the transmitters transmit signals in a plurality of directions. The transmitters may be disposed such that the signals transmitted by the transmitters in the plurality of postures are propagated to the receivers. Therefore, even if the workpiece turns over, the posture of the workpiece may be detected.

In the workpiece detection system, it is preferable that the plurality of transmitters facing different directions be disposed in different layout patterns.

In this case, the transmitters are disposed in different layout patterns for each direction in which the workpiece is faced. Accordingly, by detecting the layout patterns, the position calculator may recognize which surface of the workpiece faces the receiver.

In the workpiece detection system, it is preferable that the workpiece include a transmitter support member, and that the transmitter be disposed on the transmitter support member.

In this case, the workpiece and the plurality of transmitters may be separated by separating the workpiece from the transmitter support member. Accordingly, the transmitters may be more readily separated from the workpiece compared to when the plurality of transmitters are disposed directly on the workpiece.

It is preferable that the workpiece include a start transmission signal receiving part, and a start transmission signal sender that transmits a start transmission signal to the start transmission signal receiving part, in that the transmitter sends the first signal after the start transmission signal receiving part receives the start transmission signal.

In this case, the start transmission signal sender instructs each transmitter when to transmit the signal (first signal). The position calculator then detects the timing of transmitting the signal and the timing at which the receiver receives the signal. The position calculator may therefore detect the distance between the receiver and the transmitter using the propagation velocity of the signal and the timing of sending and receiving the signal.

In the workpiece detection system, it is preferable that the start transmission signal sender send the start transmission signal including a predetermined code, that the start transmission signal receiving part receive the start transmission signal, and that the transmitter send the first signal only if the predetermined code corresponds with a preset code.

In this case, the transmitter to perform the transmission is specified using the code. Therefore, it is possible to distinguish the transmitter that performs the transmission. If there is a plurality of types of workpieces, each type of workpiece may be distinguished by establishing in advance the relation between the type of the workpiece and the code to which the start transmission signal receiving part disposed on the workpiece reacts.

In the workpiece detection system, it is preferable that some of the transmitters transmit the first signals having waveforms of different frequencies, and that, after the receivers receive the first signals, the position calculator detect the waveform frequencies of the first signals.

In this case, the transmitters transmit signals (first signals) having waveforms of different frequencies. The position calculator then detects the waveform frequency of each signal. Thus, the position calculator may distinguish each transmitter using the frequency information of the signal. As a result, the position calculator may distinguish the workpiece having the transmitter that transmits the signal.

In the workpiece detection system, it is preferable that: the receivers be disposed at substantially equal intervals with respect to a moving direction of the workpiece; the disposed receivers be sequentially arranged in numbers of one, two, one, two; and at least three receivers receive the first signal transmitted from one of the transmitters during movement of the workpiece.

In this case, one receiver and two receivers, constituting a combination of three receivers, receive the signals (first signals). Compared to when the receivers are sequentially arranged in numbers of three, three, three, three, and so on with respect to the moving direction, the locations of the receivers may be detected with a fewer number of receivers.

According to a second aspect of the invention, a picking apparatus includes the workpiece detecting system of the first aspect, a workpiece transfer unit that transfers the workpiece, and a robot that grabs and transfers the workpiece to a predetermined location.

In this case, after detecting the location of the workpiece in a short period of time, the robot grabs the workpiece. Accordingly, the time between the detection and transfer of the workpiece may become shorter, and the workpiece may be transferred productively.

It is preferable that the picking apparatus further include an imaging device and an image calculator that detects position and configuration of the workpiece using an image picked up by the imaging device, in that the image calculator inputs position information of the workpiece from the position calculator, specifies a location in the image where the workpiece is imaged, and analyzes the specified location.

In this case, the image calculator inputs the position information of the workpiece from the position calculator. Then, the imaging device picks up the image of the workpiece. The image calculator specifies the location in the image where the workpiece is imaged using the position information of the workpiece. The image calculator then analyzes the specified location in the image so as to detect the location and configuration of the workpiece in detail. Accordingly, the analysis area of the image may be smaller than when the image calculator analyzes the whole picked up image. As a result, the location and posture of the workpiece may be detected in a short time.

In the picking apparatus, it is preferable that the transmitters be disposed on the robot and on a workpiece transfer unit at fixed positions against the robot.

In this case, the transmitters are disposed on the robot and at equal positions against the robot. Since the position calculator detects the locations of the transmitters on the workpiece transfer unit and the locations of the transmitters on the robot, the positional relationship between the robot and the workpiece transfer unit may be readily recognized. Therefore, initial setting of the positional relationship between the robot and the workpiece transfer unit may be productively conducted.

According to a third aspect of the invention, a picking method includes: transferring a workpiece by a workpiece transfer unit as a first transfer step, transmitting an ultrasonic wave signal from each of a plurality of transmitters disposed on the workpiece and detecting a posture of the workpiece using a receiver as a first detection step, and grabbing and transferring the workpiece by a robot as a second transfer step, in that the posture of the workpiece is detected based on a time of arrival of the ultrasonic wave signal to each of the plurality of receivers, the signal being transmitted from each transmitter in the first detecting step.

In this case, the workpiece is transferred in the first transfer step. The posture of the moving workpiece is then detected in the first detection step. Then, in the second transfer step, the robot grabs and transfers the workpiece using the information on the posture of the workpiece. In the first detection step, the locations of the plurality of transmitters are detected by measuring the arrival times of the ultrasonic wave signals. Therefore, because the locations of the transmitters may be detected based on less information compared to the method using the imaging device, the posture of the workpiece may be detected in a short time.

It is preferable that the picking method further include: detecting a location of the workpiece in the first detection step; picking up an image of the workpiece using an imaging device and detecting the location and posture of the workpiece by analyzing the picked up image as a second detection step which is carried out between the first detection step and the second transfer step; and analyzing, in the second detection step, a portion of the image using information on the location of the workpiece that is detected in the first detection step.

In this case, the workpiece is picked up in the second detection step, and, by analyzing the picked up image, the position and posture of the workpiece is detected. At this time, a portion of the image is analyzed using the position information of the workpiece detected in the first detection step. Therefore, the analysis area of the image is smaller than when analyzing the whole picked up image. As a result, the location and posture of the workpiece may be detected in a short time.

According to a fourth aspect of the invention, a transfer system includes: a first transport unit, a second transport unit, a robot; a workpiece that is placed on the first transport unit and includes a plurality of transmitters transmitting signals; and three or more of receivers. In the system, the receivers receive the signals transmitted by the transmitters and detect locations of the transmitters using times of arrival of the signals received by the receivers. A posture of the workpiece is detected from information on the locations of the transmitters. The robot grabs a workpiece and places the workpiece on the second transport unit.

### BRIEF DESCRIPTION OF THE DRAWINGS

The invention will be described with reference to the accompanying drawings, wherein like numbers reference like elements.

FIG. 1 is a perspective diagram schematically showing the structure of a picking apparatus according to a first embodiment of the invention.

FIG. 2A is a plan pattern diagram showing a workpiece from a Z direction.

FIG. 2B is a plan pattern diagram showing the workpiece in a direction opposite from the Z direction.

FIG. 2C is a side pattern view of the workpiece.

FIG. 3A is a block diagram illustrating electrical control of an ultrasonic wave tag.

FIG. 3B is a pattern diagram showing layout of ultrasonic wave receiving devices.

FIG. 4 is a block diagram illustrating electrical control of a picking apparatus.

FIG. 5 is a flowchart showing manufacturing steps of picking and transferring the workpiece.

FIG. 6 is a flowchart showing manufacturing steps of picking and transferring the workpiece.

FIGS. 7A through 7D are diagrams explaining a picking method.

FIGS. 8A through 8C are diagrams explaining the picking method.

FIGS. 9A through 9D are diagrams explaining the picking method.

FIGS. 10A through 10C are plan diagrams of workpieces having ultrasonic wave tags disposed thereon according to a second embodiment of the invention.

FIG. 11 is a flowchart showing a first detection step.

FIGS. 12A and 12B are pattern diagrams showing a workpiece according to a modified example.

### DESCRIPTION OF EXEMPLARY EMBODIMENTS

Embodiments of the invention will now be described in accordance with the drawings.

In the drawings, elements are sized differently so that they are recognizable on each drawing.

### First Embodiment

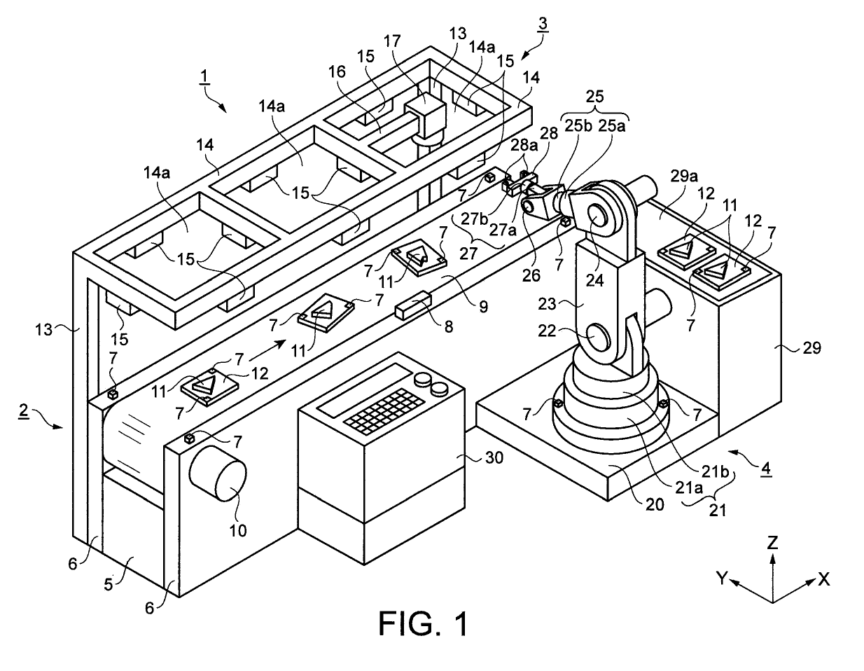

A picking apparatus including a workpiece detecting system and a picking method characteristic of a first embodiment of the invention will be explained in accordance with FIGS. 1 through 9. The picking method is a method for transferring a workpiece by grabbing, transferring, and releasing the workpiece. A picking apparatus is an apparatus for implementing the picking method.

FIG. 1 is a perspective diagram schematically showing the structure of the picking apparatus. Referring to FIG. 1, a picking apparatus 1 mainly includes a conveyer 2, a position detecting unit 3, and a robot 4. The conveyer 2 has a base 5 which is formed long in one direction. A longitudinal direction of the base 5 is an X direction. A direction opposite from a gravitational direction is a Z direction, and a direction orthogonal to the X and Z directions is a Y direction.

A pair of sideboards 6 is disposed on both sides of the base 5 in the Y direction. Ultrasonic wave tags 7 are disposed on both sides of each sideboard 6 in the X direction, on an upper surface of each sideboard 6. Each ultrasonic wave tag 7 houses an ultrasonic wave source so as to send ultrasonic waves. Also, a radio wave transmitting device 8 is disposed on an upper surface of the sideboard 6 in a direction opposite from the Y direction. The radio wave transmitting device 8 includes a transmitting circuit and an antenna and sends a radio wave signal having a predetermined waveform.

Disposed between the two sideboards is a belt 9. The belt 9 is made of a cylindrical sheet and includes therein a pulley not shown in the drawing. The pulley provides the belt 9 with a predetermined tension in the X direction. A motor 10 is provided on a surface of the sideboard 6 opposite from the Y direction, on an opposite side in the X direction of this sideboard 6. A drive shaft of the motor 10 is coupled to the pulley. Workpieces 11 are placed on the upper surface of the belt 9 and supported by workpiece supports 12. Each workpiece support 12 is provided with the plurality of ultrasonic wave tags 7. By driving the motor 10, the belt 9 conveys the workpieces 11 in the X direction.

Two support poles 13 are disposed upright in the Z direction, on a side surface of the conveyer 2 in the Y direction. A receiving device support 14 is disposed on the support poles 13. The outer shape of the receiving device support 14 is made rectangular with beams. Two beams are disposed on an inner side of the receiving device support 14, thereby providing three rectangular windows 14a to the receiving device support 14. The ultrasonic wave receiving devices 15 are disposed on the beams at locations corresponding to sides of the three windows 14a. The ultrasonic wave receiving devices 15 are devices to receive ultrasonic wave signals and are disposed on a surface of the receiving device support 14 on the side adjacent to the conveyer 2. The ultrasonic wave receiving devices 15 are located above the belt 9 so as to receive the ultrasonic wave signals sent from the ultrasonic wave tags 7.

An imaging support 16 is provided to the window 14a in the X direction of the receiving device support 14. An imaging device 17 is coupled to the imaging support 16. The imaging device 17 takes images of the workpieces 11 placed on the belt 9.

The robot 4 is located in the X direction of the conveyer 2, in a direction opposite from the Y direction. The robot 4 includes a base 20 having a turntable 21 provided thereon. The turntable 21 includes a fixed base 21a and a rotary shaft 21b. The turntable 21 includes therein a servomotor and a deceleration mechanism and enables the rotary shaft 21b to rotate and stop with high angle precision. The ultrasonic wave tags 7 are disposed on the fixed base 21a. The locations of the ultrasonic wave tags 7 disposed on the conveyer 2 and the locations of those disposed on the turntable 21 are detected using the ultrasonic wave receiving devices 15. It is thereby possible to establish data of relative locations of the conveyer 2 to the robot 4.

The rotary shaft 21b of the turntable 21 is coupled to a first joint 22, and the first joint 22 is coupled to a first arm 23. The first arm 23 is coupled to a second joint 24, and the second joint 24 is coupled to a second arm 25. The second arm 25 includes a fixed shaft 25a and a rotary shaft 25b, and the second arm 25 rotates around the rotary shaft 25b using the longitudinal direction of the second arm 25 as a shaft. Coupled to the rotary shaft 25b of the second arm 25 is a third joint 26, and coupled to the third joint 26 is a third arm 27. The third arm 27 includes a fixed shaft 27a and a rotary shaft 27b, and the third arm 27 rotates around the rotary shaft 27b using the longitudinal direction of the third arm 27 as a shaft. A hand 28 is coupled to the rotary shaft 27b of the third arm 27 and has a pair of fingers 28a. The hand 28 has a servomotor and a linear motion mechanism driven by the servomotor. The gap between the fingers 28a is changed by use of the linear motion mechanism changes.

The first, second, and third joints 22, 24, 26 include therein a servomotor and a deceleration mechanism so as to rotate and stop the first, second, and third arms 23, 25, 27 with high angle precision. As described, the robot 4 includes many joints and rotary mechanisms. By controlling these joints and rotary mechanisms as well as the fingers 28a, it is possible to grab the workpieces 11.

A storing device 29 is disposed in the X direction of the robot 4. The robot 4 transfers the workpieces 11 from above the belt 9 onto an upper surface 29a of the storing device 29. The storing device 29 includes therein an elevator mechanism so as to lift down the upper surface 29a depending on the quantity of the workpieces 11. The storing device 29 evens out the height of an area for placing the workpieces 11.

Disposed in a direction opposite from the X direction of the robot 4 is a controlling apparatus 30. The controlling apparatus 30 is a device to control the picking apparatus 1 that includes units such as the conveyer 2, the position detecting unit 3, and the robot 4.

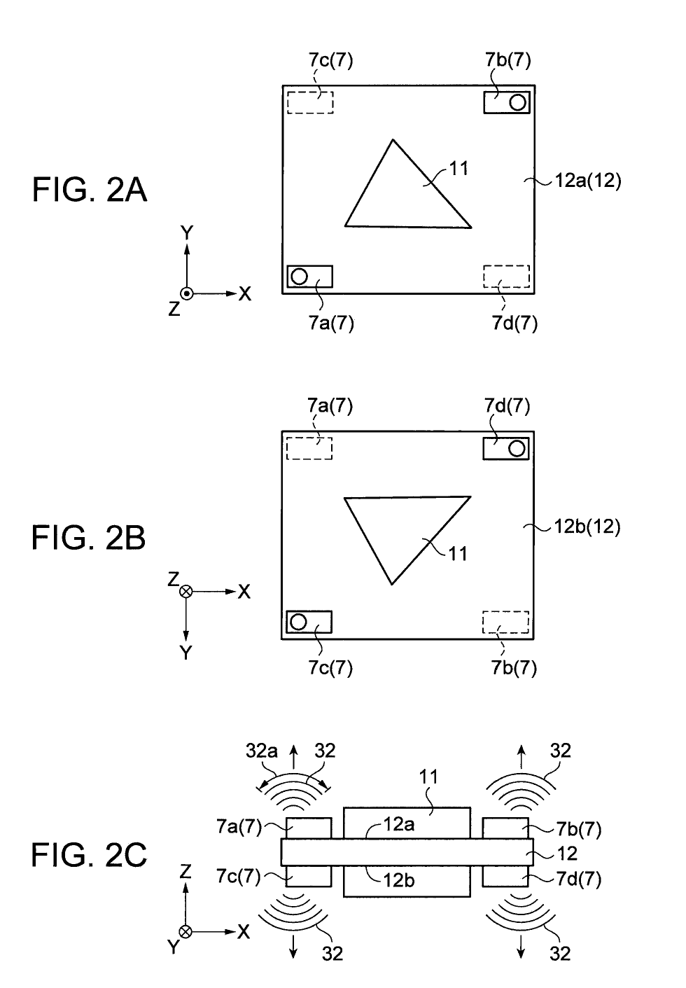

FIGS. 2A through 2C are pattern diagrams illustrating the workpieces. FIG. 2A is a plan pattern diagram showing the workpiece from the Z direction. FIG. 2B is a plan pattern diagram showing the workpiece in a direction opposite from the Z direction. FIG. 2C is a side pattern view of the workpiece. Referring to FIGS. 2A through 2C, the workpiece 11 is fixed to the workpiece support 12. A first ultrasonic wave tag 7a and a second ultrasonic wave tag 7b are disposed on an upper surface 12a of the workpiece support 12 facing the Z direction. The first and second ultrasonic wave tags 7a and 7b transmit ultrasonic waves 32 in the Z direction. A third ultrasonic wave tag 7c and a fourth ultrasonic wave tag 7d are disposed on a lower surface 12b of the workpiece support 12, the lower surface 12b facing a direction opposite from the Z direction. The third and fourth ultrasonic wave tags 7c and 7d transmit the ultrasonic waves 32 in the direction opposite from the Z direction.

The ultrasonic waves 32 transmitted by the tags 7 advance and spread conically. An angle 32a and frequency of the spreading waves 32 are not particularly specified since the angle and frequency vary depending on the specification of the tags 7. In the present embodiment, for example, the spread angle 32a is set at about 100 degrees. The frequency of the waves 32 employed herein is near 40K hertz.

The workpiece support 12 having the workpieces 11 thereon is planarly configured. Therefore, when placing the workpiece support 12 on the belt 9, it is possible that either the upper surface 12a or the lower surface 12b of the workpiece support 12 may face the direction of the ultrasonic wave receiving devices 15. The ultrasonic wave tags 7 are disposed on the upper and lower surface 12a, 12b of the workpiece support 12. Accordingly, the tags 7 can transmit the ultrasonic waves 32 to the receiving devices 15 whether the surface facing the receiving device 15 is the upper surface 12a or the lower surface 12b.

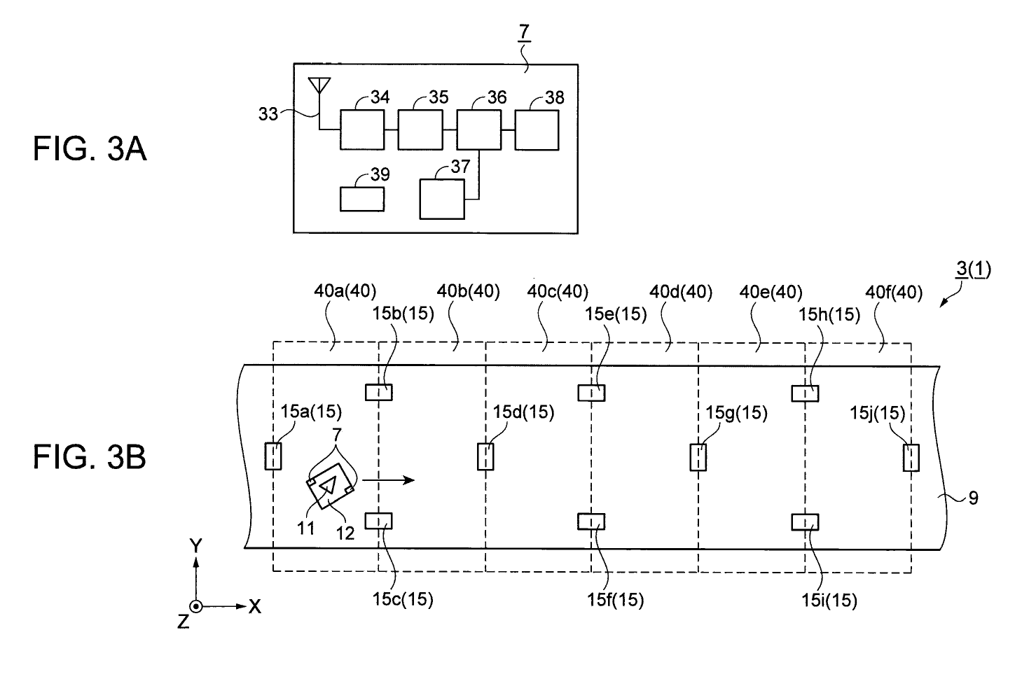

FIG. 3A is a block diagram illustrating electrical control of the ultrasonic wave tag. With reference to FIGS. 3A and 3B, each ultrasonic wave tag 7 includes an antenna 33. The antenna 33 is coupled to a receiving circuit 34. The receiving circuit 34 is a circuit for amplifying weak radio waves that the antenna 33 receives. The antenna 33 and the receiving circuit 34 receive the radio wave signal sent by the radio wave transmitting device 8. The receiving circuit 34 is coupled to a code analyzing circuit 35. The code analyzing circuit 35 is a circuit for analyzing the radio wave signal sent by the radio wave transmitting device 8. The radio wave signal contains a code signal and a transmission timing signal. The code analyzing circuit 35 analyzes the code signal and determines whether or not to transmit the ultrasonic waves 32. The code of the code signal indicates a recognition number. The code is set in each tag 7. The code analyzing circuit 35 determines whether or not the received code signal corresponds with the code set in the tag 7. Then, if the received code signal corresponds with the code set in the tag 7, the code analyzing circuit 35 decides on transmission of the ultrasonic waves 32.

The code analyzing circuit 35 is coupled to a transmission controlling circuit 36. The transmission controlling circuit 36 is coupled to a transmission signal forming circuit 37 and a transmitting circuit 38. The transmission signal forming circuit 37 includes an oscillating circuit and forms a voltage signal of a waveform established in advance. The pattern of the waveform may be, but not limited to, a sine wave, a rectangular wave, or a triangular wave. In this embodiment, the sine wave is employed, for example. The frequency of the waveform is not limited to a specific kind, and a plurality of waveforms may be formed. However, it is not always necessary to form a plurality of waveforms of a plurality of frequencies if only one kind of wavelength is used. The transmission signal forming circuit 37 outputs the formed voltage signal to the transmission controlling circuit 36.

The transmission controlling circuit 36 is a circuit to control transmission of signals. When the code analyzing circuit 35 decides on transmission of the ultrasonic waves 32, the transmission signal forming circuit 37 outputs the formed voltage signal to the transmitting circuit 38. Then, in synchronization with the transmission timing signal, the voltage signal is outputted. The transmitting circuit 38 includes an amplifying part and an ultrasonic wave output part. The amplifying part amplifies the inputted voltage signal and outputs the amplified signal to the ultrasonic wave output part. The ultrasonic wave output part is composed of elements such as a vibrating plate having a piezoelectric element, and the vibrating plate is vibrated in response to the voltage signal. As the vibrating plate vibrates the air, the ultrasonic waves 32 are transmitted.

Each ultrasonic wave tag 7 includes a power source 39. A battery, a storage battery, or the like may be used as the power source 39. In this embodiment, a lithium secondary battery is employed, for example. The power source 39 supplies power to each of the circuits included in the ultrasonic wave tag 7.

In other words, the tag 7 receives the radio wave signal. Then, if the code signal contained in the radio wave signal corresponds with the code established in the tag 7 in advance, the ultrasonic waves 32 are transmitted. Then, in synchronization with the transmission timing signal contained in the radio wave signal, the ultrasonic waves 32 are transmitted.

FIG. 3B is a pattern diagram showing the layout of the ultrasonic wave receiving devices. Referring to FIG. 3B, the workpiece 11 is placed on the belt 9 and moves along with the belt 9. The ultrasonic wave receiving devices 15, i.e. first to tenth ultrasonic wave receiving devices 15a to 15j, are disposed at locations facing the belt 9. Six receiving regions 40, i.e. first to sixth region 40a to 40f, are set on the belt 9. The first region 40a is set at an upstream side in the moving direction of the belt 9, and the sixth region 40f is set at a downstream side.

The ultrasonic wave receiving devices 15 are disposed at boundaries of the adjacent regions. For example, the second and third ultrasonic wave receiving devices 15b, 15c are disposed between the first and second regions 40a, 40b. Then, the second and third ultrasonic wave receiving devices 15b, 15c receive the waves 32 sent from the first and second regions 40a, 40b. Similarly, the fourth ultrasonic wave receiving device 15d receives the waves 32 sent from the second and third regions 40b, 40c.

Three ultrasonic wave receiving devices 15 are disposed in each of the receiving regions 40 and receive the waves 32 sent from each of the receiving regions 40. When the workpiece 11 in the first region 40a transmits the waves 32, the first, second, and third ultrasonic wave receiving devices 15a, 15b, 15c receive the waves 32. Then, when the workpiece 11 in the second region 40b transmits the waves 32, the second, third, and fourth ultrasonic wave receiving devices 15b, 15c, 15d receive the waves 32. Then, when the workpiece 11 moves from the first region 40a to the sixth region 40f, the ultrasonic wave receiving devices 15 located in the receiving regions 40 sequentially receive the waves 32.

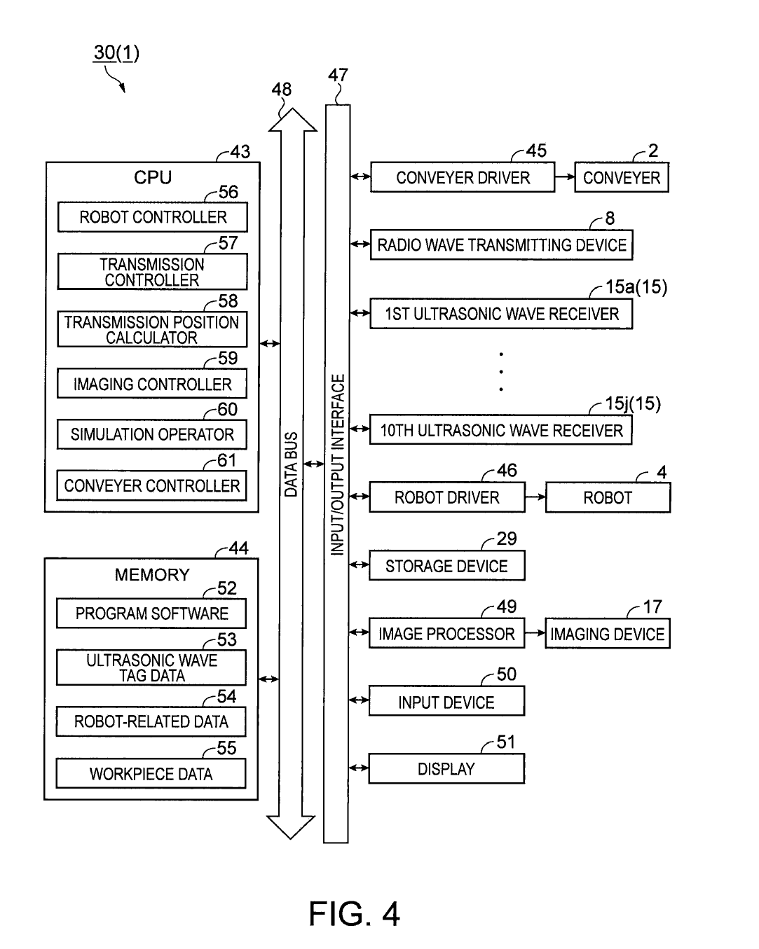

FIG. 4 is a block diagram illustrating electrical control of the picking apparatus. Referring to FIG. 4, the controlling apparatus 30 includes a central processing unit (CPU) as a processor that performs various types of computing processes, and a memory 44 as an attribute storing unit that stores various types of information.

Coupled to the CPU 43 are a conveyer driver 45, a radio wave transmitting device 8, ultrasonic wave receiving devices 15, a robot driver 46, and the storing device 29, with an input/output interface 47 and a data bus 48 therebetween. An image processor 49, an input device 50, and a display 51 are also coupled to the CPU 43, with the input/output interface 47 and the data bus 48 therebetween.

The conveyer driver 45 is coupled to the conveyer 2 and controls the conveyer 2. The conveyer driver 45 controls the moving and stopping of the belt 9 as well as the speed of the belt 9 in motion. The robot driver 46 is a device to control operations of the robot 4. The robot driver 46 outputs information concerning the posture of the robot 4 to the CPU 43. Then, the hand 28 is moved to a location designated by the CPU 43, thereby enabling the fingers 28a to operate.

The image processor 49 is coupled to the imaging device 17 and analyzes images picked up by the imaging device 17. The imaging device 17 picks up images of the workpieces 11, and the image processor 49 analyzes the locations and postures of the workpieces 11 in the images.

The input device 50 is a device that inputs the codes of the ultrasonic wave tags 7 and operation conditions such as how the robot 4 grabs the workpiece supports 12. For example, the input device 50 is a device that receives coordinates indicating the configuration of the workpiece support 12 for each workpiece 11 from an external device (not shown) and inputs the coordinates. The display 51 is a device that displays data and operational states of the workpiece 11 and the ultrasonic wave tags 7. Based on the information displayed on the display 51, an operator performs an input operation using the input device 50.

The memory 44 is a concept that includes semiconductor memory, such as random access memory (RAM) and read only memory (ROM), and external storing devices such as hard disc and digital versatile disc-read only memory (DVD-ROM). Functionally speaking, a storage area for storing program software 52 containing control procedures for operating the picking apparatus 1 is established in the memory 44. Also established in the memory 44 is a storage area for storing ultrasonic wave tag data 53 that is information such as the codes established in the ultrasonic wave tags 7. Also stored in the memory 44 is the relationship between each workpiece 11 and the ultrasonic wave tags 7. Established also in the memory 44 is a storage area for storing robot-related data 54 that is information such as relative locations of the conveyer 2, the location detecting unit 3, and of the storing device 29 with respect to the robot 4. Also established in the memory 44 is a storage area for storing work data 55 that is data such as the configuration of each workpiece 11 and a location at which the fingers 28a of the robot 4 pinch the workpiece 11 when grabbing the workpiece 11. Stored in the work data 55 are codes of the ultrasonic wave tags 7 and attribute information of the workpieces 11. Included in the attribute information are configurations of the workpieces 11 and the workpiece supports 12, layout of the ultrasonic wave tags 7, compositions of the codes and the workpieces 11 that are information required in the operation processes. Established additionally in the memory 44 are a storage area performing as a work area for the CPU 43, a temporary file, and the like, as well as other types of storage areas.

The CPU 43 identifies the workpieces 11 and controls the transfer of the workpieces 11 in accordance with the program software 52 stored in the memory 44. The CPU 43 includes a robot controller 56 as a specific function-performing part that drives the robot 4 and transfers the workpieces 11. In addition, the CPU 43 includes a transmission controller 57 that controls the radio wave transmitting device 8 so as to make a specific tag 7 to transmit the waves. Moreover, the CPU 43 includes a transmission position calculator 58 that calculates the location of each tag 7 using the waves 32 transmitted by the ultrasonic wave receiving devices 15. The CPU 43 also includes an imaging controller 59 that controls when the imaging device 17 picks up an image and which portion on the picked up image is to be analyzed by the image processor 49. The CPU 43 also includes a simulation operator 60 that simulates the operations of the arms and hands 28 of the robot 4. In addition, the CPU 43 includes a conveyer controller 61 that controls the operation of the belt 9 in coordination with the operation of the robot 4.

Picking Method

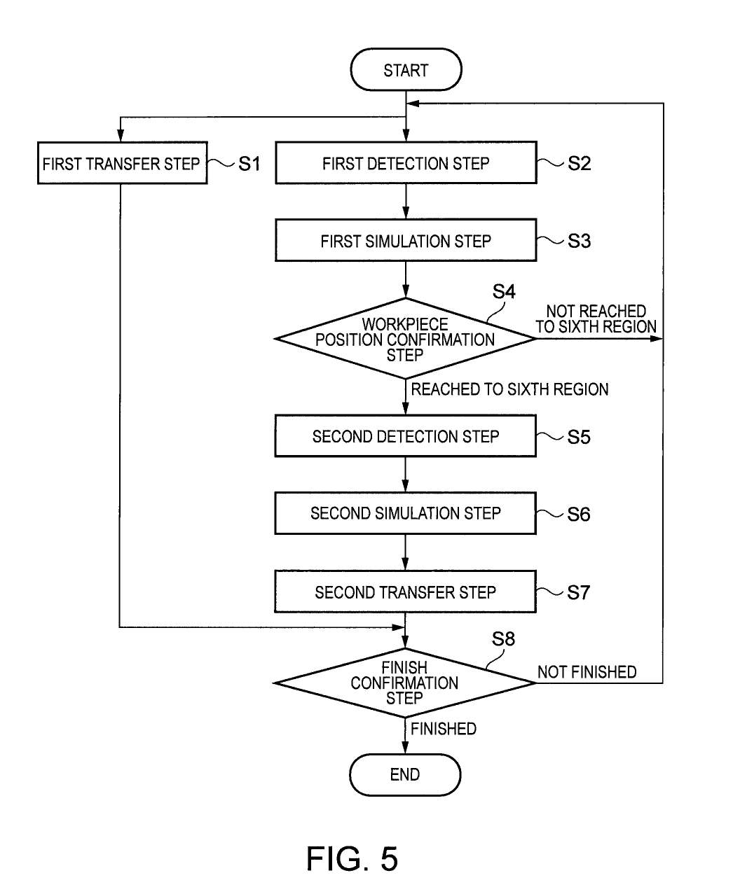

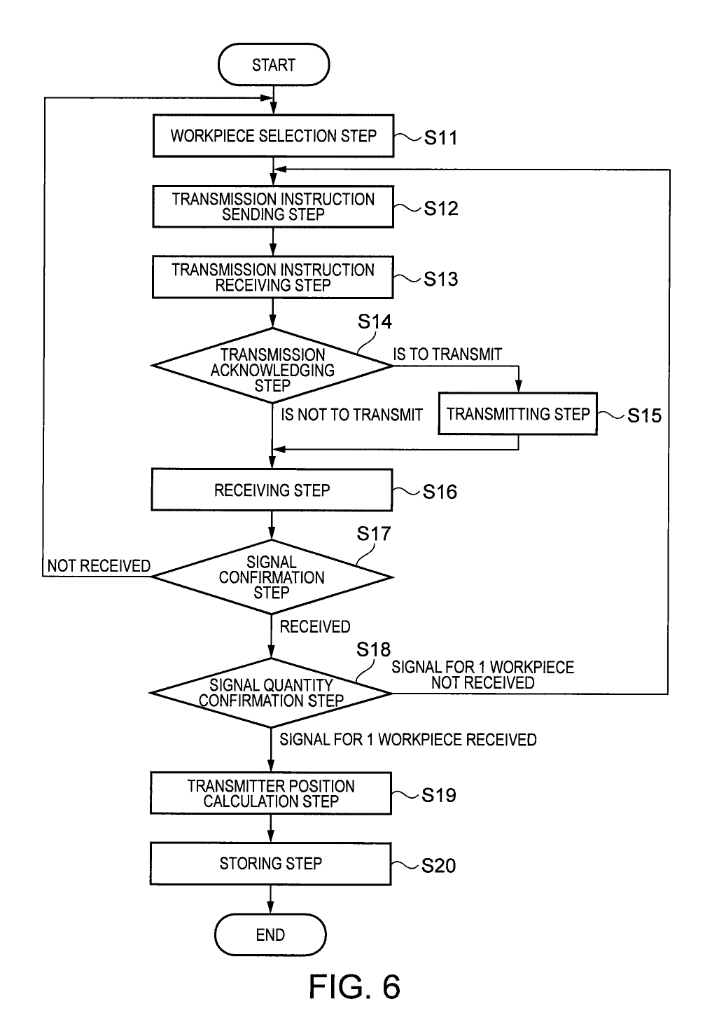

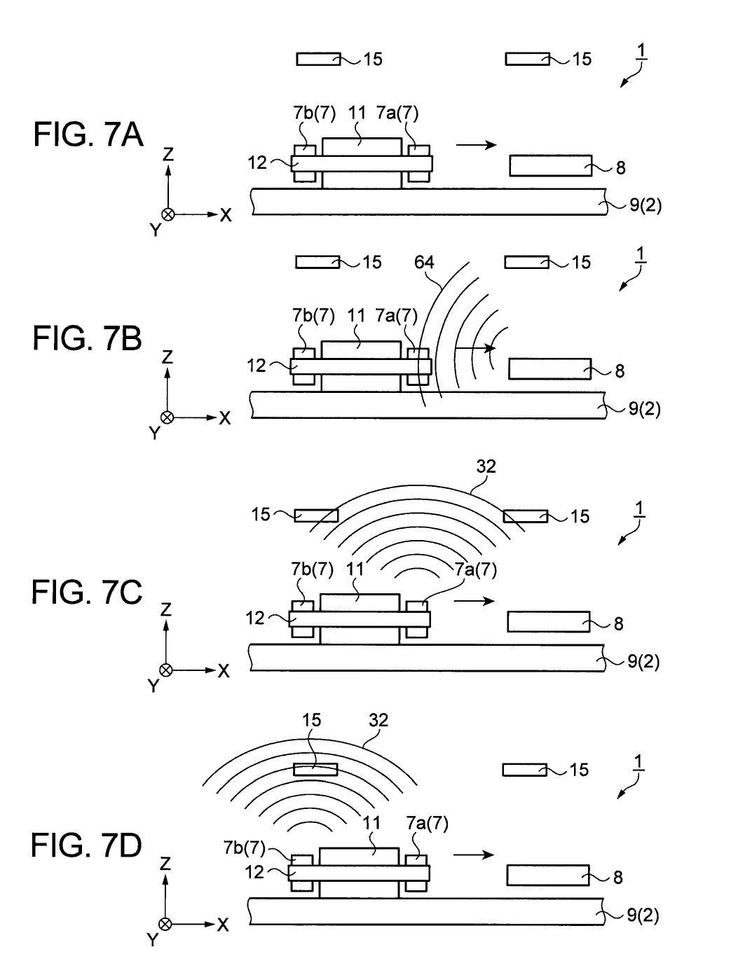

Using the picking apparatus 1 as described above, the picking method for transferring the workpieces 11 from the conveyer 2 to the storing device 29 will now be described with reference to FIGS. 5 through 9. FIGS. 5 and 6 are flowcharts showing steps of picking and transferring the workpieces. FIGS. 7 through 9 are diagrams to explain the picking method.

In the flowchart with reference to FIG. 5, step S1 is conducted in parallel with steps S2 through S7. Step S1 corresponds to a first transfer step, in which the workpiece is transferred by means of the conveyer. The step then proceeds to step S8. Step S2 corresponds to a first detection step, in which the ultrasonic waves sent by the ultrasonic wave tags are received, and the location of the workpiece is detected. This is followed by step S3. Step S3 corresponds to a first simulation step, in which the location to which the workpiece is transferred is predicted and the locus of the hand of the robot moving to that location is simulated. The next step is step S4. Step S4 corresponds to a work position confirmation step and is a step for confirming in which region out of the first to sixth regions the workpiece is located. The region where the robot grabs the workpiece is the sixth region. If the workpiece does not reach to the sixth region, the step proceeds to step S2. If the workpiece reaches to the sixth region, the step proceeds to step S5. Step S5 corresponds to a second detection step, in which the location of the workpiece is detected using an image pick up camera and the image processor. The step then proceeds to step S6. Step S6 corresponds to a second simulation step. In this step, the location to which the workpiece is to be transferred is estimated, and the moving locus of the robot's hand to this location is simulated with high precision. The next step is step S7. Step S7 corresponds to a second transfer step, in which the robot transfers the workpiece from the belt to the storing device. Then the step proceeds to step S8. Step S8 is an end confirmation step to confirm that all the workpieces have flowed. If there are workpieces still flowing and the operation is not finished, the step proceeds to steps S1 and S2. If there is no workpieces flowing and the operation is finished, the steps of picking and transferring the workpieces end.

The first detection step of step S2 will now be described in detail using the flowchart with reference to FIG. 6. Step S11 corresponds to a workpiece selection step, in which a type of the workpieces to be detected is determined. This is followed by step S12. Step S12 corresponds to a transmission instruction sending step, in which a transmission instruction signal is sent to a specific ultrasonic wave tag. The next step is step S13. Step S13 corresponds to a transmission instruction receiving step, in which the tag receives the transmission instruction signal. The step then proceeds to step S14.

Step S14 corresponds to a transmission acknowledging step, in which the tag analyzes the transmission instruction and determines whether or not this tag is to perform the transmission. The tag that is not to perform the transmission moves to step S16. The tag that is to perform the transmission moves to step S15. Step S15 corresponds to a transmitting step, in which ultrasonic waves are transmitted. The step then proceeds to step S16. Step S16 corresponds to a receiving step, in which the ultrasonic wave receiving device receives the ultrasonic waves. This is followed by step S17.

Step S17 corresponds to a signal confirmation step, which is a step of confirming if there is the ultrasonic wave receiving device that has received the waves. If there is no receiving device having received the waves, the step proceeds to step S11. If there is a receiving device having received the waves, the step proceeds to step S18. Step S18 corresponds to a signal quantity confirmation step. One workpiece is provided with two tags. This step S18 is the step of confirming if the ultrasonic wave signals from the two tags have been received. If a signal for one workpiece is not received, the step moves to step S12. If a signal for one workpiece is received, the step moves to step S19.

Step S19 corresponds to a transmitter position calculation step, in which the position of the tag is calculated. The next step is step S20. Step S20 corresponds to a storing step, in which the position of the tag is stored in the memory. The first detection step of step S1 ends here.

Referring to FIGS. 7 through 9, the workpiece picking method will now be described in detail in association with the steps shown in FIGS. 5 and 6. FIG. 7A is a diagram corresponding to the first transfer step of step S1. Referring to FIG. 7A, in step 1, the workpieces 11 are placed on the belt 9. The workpieces 11 are then transferred by the belt 9.

In the workpiece selection step of step S11, the transmission controller 57 selects one workpiece 11 and the code of the tag 7 disposed on this workpiece 11 from the ultrasonic wave tag data 53. The ultrasonic wave tag data 53 stores information on the plurality of workpieces 11. The workpieces 11 are allotted numbers. By selecting the workpieces 11 in the order of the allotted numbers, the transmission controller 57 can select all of the workpieces 11. Each workpiece 11 has two ultrasonic wave tags 7, and each tag 7 is given a code. The transmission controller 57 then selects one of the two tags 7 and acquires the code for the selected tag 7.

FIG. 7B is a diagram corresponding to the transmission instruction sending step of step S12. In step S11, the transmission controller 57 outputs an instruction signal for instructing transmission of the radio wave signal 64 to the radio wave transmitting device 8. Referring to FIG. 7B, in step S12, the radio wave transmitting device 8 outputs the radio wave signal 64. Various types of workpieces 11 are disposed on the belt 9. The radio wave signal 64 is sent to these workpieces 11.

In the transmission instruction receiving step of step S13, the tags 7 receive the radio wave signal 64. The radio wave signal 64 contains a code signal and a transmission timing signal. In the transmission acknowledging step of step S14, each tag 7 analyzes the received signal and determines if the code signal corresponds with the code established in the tag 7. Then, the first tag 7a of which established code signal corresponds with the code signal transmits the ultrasonic waves 32.

FIG. 7C is a diagram corresponding to the transmitting step of step S15 and the receiving step of step 16. Referring to FIG. 7C, in step S15, the first tag 7a transmits the ultrasonic waves 32 in the Z direction. The ultrasonic wave receiving devices 15 are disposed in the Z direction of the belt 9. Then, in the receiving step of step S16, the plurality of receiving devices 15 receive the ultrasonic waves 32. The transmission controller 57 detects the time between transmission of the waves by the first tag 7a and receipt of the waves by each receiving device 15 and stores the time in the memory 44.

Examples of the method for detecting the time between the transmission and receipt of the waves received by the receiving device 15 may be: a method of detecting amplitude of the ultrasonic waves 32, a method of detecting timing at which a waveform of the ultrasonic waves corresponds with a reference waveform, and a phase matching method in which the ultrasonic waves 32 having two frequencies are transmitted, and then the phase of the transmitted waves 32 is detected. The phase matching method is disclosed in JP-A-2006-242640. Because the phase matching method has high measurement precision, the time between the transmission and receipt of the ultrasonic waves 32 can be measured with high precision. In the embodiment, for example, the phase matching method is employed.

Then, the step proceeds to the signal confirmation step of step S17. If the ultrasonic wave receiving device 15 does not receive the waves 32, the transmission controller 57 determines that the workpiece 11 selected in the workpiece selection step of step S11 is not on the belt 9. Then, the step goes to step S11 so as to select another workpiece.

In the signal quantity confirmation step of step S18, the transmission controller 57 confirms combinations of the tags 7 disposed on each workpiece 11. The ultrasonic wave tag data 53 in the memory 44 stores the codes of the tags 7 disposed on each type of workpiece 11. The transmission controller 57 confirms the type of the workpiece 11 having the first tag 7a that has transmitted the waves 32. Thereafter, the transmission controller 57 confirms the code of the second tag 7b disposed on this workpiece 11. The transmission controller 57 then confirms that no waves from the tag 7 of this code have been received. Thereafter, the steps S12 through S14 are repeated.

FIG. 7D is a diagram corresponding to the transmitting step of step S15 and the receiving step of step 16. Referring to FIG. 7D, in step S15, the second tag 7b transmits the waves 32 in the Z direction. Then, the transmission controller 57 detects the time between transmission of the waves by the second tag 7b and receipt of the waves by each of the receiving devices 15 and stores the time in the memory 44.

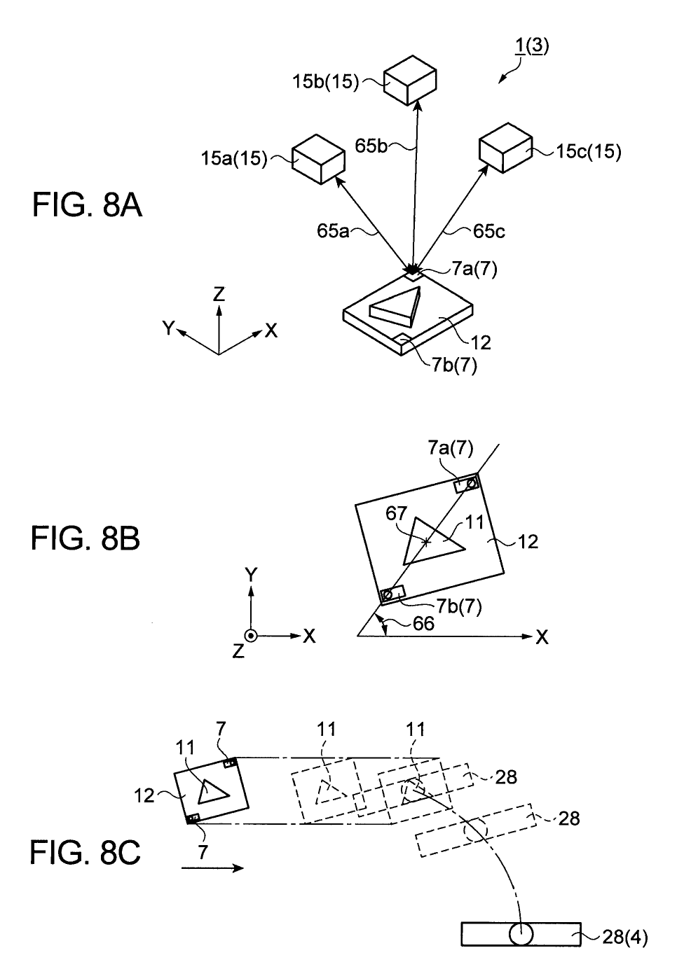

FIGS. 8A and 8B are diagrams corresponding to the transmitter position calculation step of step S19. Described now with reference to FIG. 8A is an example of detecting the position of the first tag 7a when the first tag 7a is in the first region 40a in step S19. The transmission position calculator 58 integrates propagation velocity of the waves 32 and time required for the waves 32 sent by the first tag 7a to reach to the first ultrasonic wave receiving device 15a. As a result, a first distance 65a, which is a distance between the first tag 7a and the first receiving device 15a, is calculated. By carrying out the similar calculation, a second distance 65b that is a distance between the first tag 7a and the second receiving device 15b is calculated. Similarly, a third distance 65b that is a distance between the first tag 7a and the third receiving device 15c is calculated.

The positions of the receiving devices 15 in the picking apparatus 1 are measured in advance, and the coordinates of the receiving devices 15 are stored in the robot-related data 54. The transmission position calculator 58 calculates the position of the first tag 7a in the picking apparatus 1 using a triangulation method. Using the same method, the position of the second tab 7b is calculated.

With reference to FIG. 8B, the posture of the workpiece 11 is now calculated. The posture of the workpiece 11 denotes a posture angle 66 of the workpiece 11 to moving direction of the workpiece 11. In the embodiment, the moving direction of the workpiece 11 is the X direction. The posture angle 66 is an angle between the X direction and a straight line that the first and second tags 7a and 7b pass. Then, a midpoint between the first and second tags 7a and 7b is calculated. This midpoint represents a workpiece position 67.

The transmission position calculator 58 calculates the distance between the first and second tags 7a and 7b. Then, using the distance data between the tags, the transmission position calculator 58 retrieves the corresponding workpiece 11 from the workpiece data 55 stored in the memory 44. The calculator 58 then confirms attribute information pertaining to the workpiece 11.

In the storing step of step S20, the workpiece position 67 and the posture angle 66 are stored in the memory 44 as the workpiece data 55. The first detection step of step S2 ends here.

FIG. 8C is a diagram corresponding to the first simulation step of step S3. Referring to FIG. 8C, in step S3, the location to which the workpiece 11 moves is estimated. The belt 9 of the conveyer 2 moves at a uniform speed. Since the position of the workpiece 11 at a given time has been detected, it is estimated that the workpiece 11 moves in the moving direction of the belt 9 after a predetermined time. The simulation operator 60 then calculates the locus of the hand 28 of the robot moving to the estimated position of the workpiece 11. Then, a location at which the hand 28 of the robot 4 is going to grab the workpiece 11 is determined.

In the workpiece position confirmation step of step S4, the region, out of the first to sixth regions 40a to 40f, where the workpiece 11 is located is confirmed. If the workpiece 11 is located in the first to fifth regions 40a to 40e, steps S2 through S4 are repeated. Thus, if there is a change in the posture and position of the workpiece 11 with respect to the belt 9, the transmission position calculator 58 detects the position of the tag 7 in response to the change. Because the simulation operator 60 re-conducts the simulation, the location at which the hand 28 of the robot 4 is going to grab the workpiece 11 may be corrected.

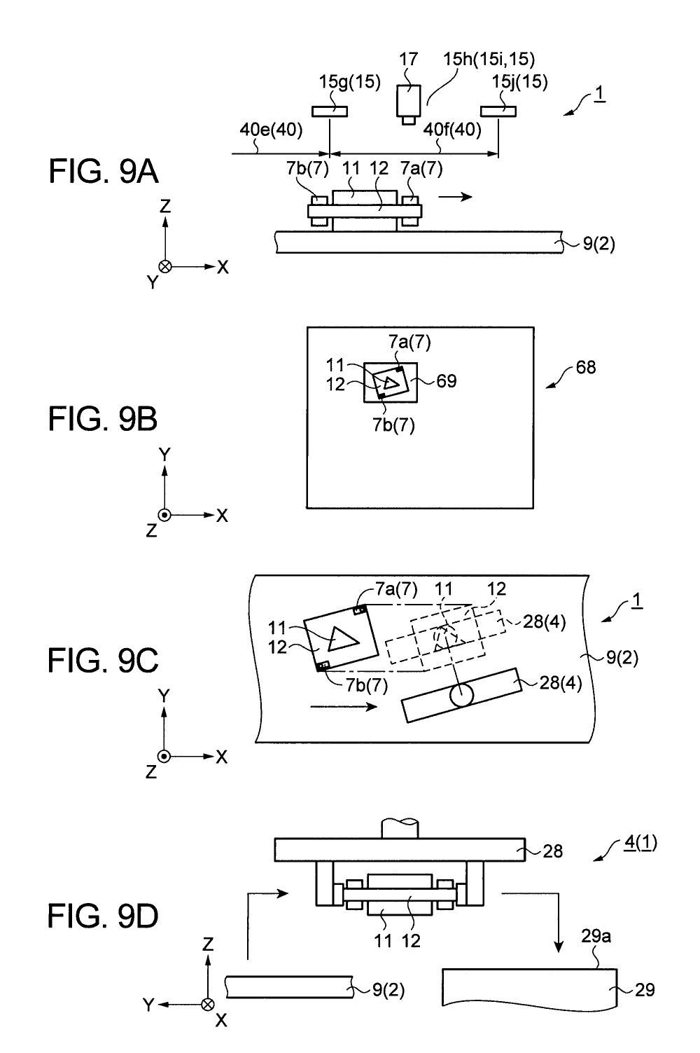

FIGS. 9A and 9B are diagrams corresponding to the second detection step of step S5. Referring to FIG. 9A, in step S5, the workpiece 11 moves from the fifth region 40e to the sixth region 40f. As in the step of step S2, the locations of the tags 7 disposed on the workpiece 11 are detected. The position and posture of the workpiece 11 are then calculated.

Thereafter, the imaging controller 59 picks up an image of the workpiece 11 by driving the imaging device 17. FIG. 9B illustrates the picked up image 68. Then, the imaging controller 59 establishes an analysis region 69 in the picked up image 68. The analysis region 69 is established using the data of the position and posture of the workpiece 11 in such a manner that the image of the workpiece 11 comes inside the analysis region 69.

Then, the image processor 49 measures in detail the position and posture of the workpiece 11. In this case, because an area for the position analysis by the image processor 49 is limited within the analysis region 69, the calculation is faster than when analyzing the whole area of the picked up image 68.

FIG. 9C is a diagram corresponding to the second simulation step of step S6. Referring to FIG. 9C, in step S6, the position to which the workpiece 11 moves after a predetermined time is estimated. Then, the simulation calculator 60 calculates the locus of the hand 28 of the robot 4 moving to the estimated position of the workpiece 11. The position at which the hand 28 of the robot 4 is going to grab the workpiece 11 is then adjusted.

FIG. 9D is a diagram corresponding to the second transfer step of step S7. Referring to FIG. 9D, in step S7, the hand 28 of the robot 4 grabs the workpiece 11 on the belt 9 and then moves onto the storing device 29 from above the belt 9. Then, the hand 28 of the robot 4 disposes the workpiece 11 on the upper surface 29a of the storing device 29. In the end confirmation step of step S8, it is confirmed whether or not the operation is to be ended. The step of picking the workpiece ends here.

As described hereinbefore, the embodiment has advantages as below.

1. According to the embodiment, the relative positions of the ultrasonic wave receiving devices 15 to the ultrasonic wave tags 7 are calculated. Since each workpiece 11 has two tags 7 disposed thereon, the posture of the workpiece 11 is detected by detecting the positions of the tags 7. Used often as the method for detecting the position and posture of the workpiece 11 is the method in which an imaging device picks up an image, and an image processor analyzes the image. This method requires much time for analysis since the amount of information is large. Another method that uses the ultrasonic wave tags 7 requires shorter time for the position calculator to detect the position and posture of the workpiece, because the position of the transmitter is detected based on less information than in the method using the image processor.

2. According to the embodiment, the distances between the tags 7 and the receiving devices 15 are measured using the ultrasonic waves 32. The ultrasonic waves 32 propagate more slowly than electromagnetic waves of light, radio waves, or the like. Thus, compared to that of the electromagnetic waves, propagation of the ultrasonic waves 32 is faster. As a result, compared to when using the electromagnetic waves, use of the ultrasonic waves 32 makes it easier to measure the propagation velocity.

3. According to the embodiment, the ultrasonic wave tags 7 transmit the ultrasonic waves 32 from the upper and lower surfaces 12a and 12b of the workpiece support 12. The tags 7 are disposed such that the ultrasonic waves 32 sent by each tag 7 are propagated to the ultrasonic wave receiving devices even in a case that the workpiece 11 turns over. Therefore, even if the workpiece 11 turns over, the position and posture of the workpiece 11 can be detected.

4. According to the embodiment, the workpiece 11 and the two tags 7 may be separated by separating the workpiece 11 from the workpiece support 12. Accordingly, compared to when two tags 7 are disposed directly on the workpiece 11, the tags 7 are more readily detached from the workpiece 11.

5. According to the embodiment, the radio wave transmitting device 8 instructs each ultrasonic wave tag 7 on the timing for sending the signal. Then, the transmission position calculator 58 detects the timing for transmitting the ultrasonic waves 32 and the timing at which the ultrasonic wave receiving devices 15 receive the waves. Therefore, the transmission position calculator 58 detects the distance between the tag 7 and the radio wave transmitting device 8 by using the propagation velocity of the waves 32 and the timing of sending and receiving the waves 32.

6. According to the embodiment, the tag 7 that transmits the waves is selected using the code. The tag 7 that transmits the waves is therefore recognized. If there is a plurality of types of workpieces 11, each type of the workpiece 11 is distinguished by establishing in advance the relation between the type of the workpiece 11 and the code to which the tag 7 disposed on the workpiece 11 reacts.

7. According to the embodiment, the ultrasonic wave receiving devices 15 are sequentially arranged in numbers of one, two, one, two, and so on with respect to the moving direction of the workpiece 11. One receiving device 15 and two receiving devices 15, constituting a combination of three receiving devices 15, receive signals. Compared to when the receiving devices 15 are arranged sequentially in numbers of three, three, three, three, and so on with respect to the moving direction of the workpieces 11, the locations of the tags 7 are detected using a fewer number of receiving devices 15.

8. According to the embodiment, after the workpiece 11 is detected in a short time, the robot 4 grabs the workpiece 11. Thus, the time between the detection and transfer of the workpieces 11 is shortened, thereby enabling productive transfer of the workpieces 11.

9. According to the embodiment, the image processor 49 inputs the position information of each workpiece 11 from the transmission position calculator 58. Then, the imaging device 17 picks up an image of the workpiece 11. The image processor 49 specifies the location of the workpiece 11 in the picked up image 68 using the position information of the workpiece 11. Then, by analyzing the specified analysis region 69 in the picked up image, the image processor 49 detects the position and configuration of the workpiece 11 in detail. Therefore, compared to when analyzing the whole image picked up by the image processor 49, the area of the image to be analyzed is reduced. As a result, the position and posture of the workpiece 11 are detected in short time.

10. According to the embodiment, the ultrasonic wave tags 7 are disposed on the sideboards 6 of the conveyer 2 and on the turntable 21 of the robot 4. Because the transmission position calculator 58 detects the locations of the tags 7 disposed on the sideboards 6 and the locations of those disposed on the turntable 21, the positional relationship between the conveyer 2 and the robot 2 may be readily recognized. Therefore, the initial setting of the positional relationship between the conveyer 2 and the robot 4 is productively conducted.

### Second Embodiment

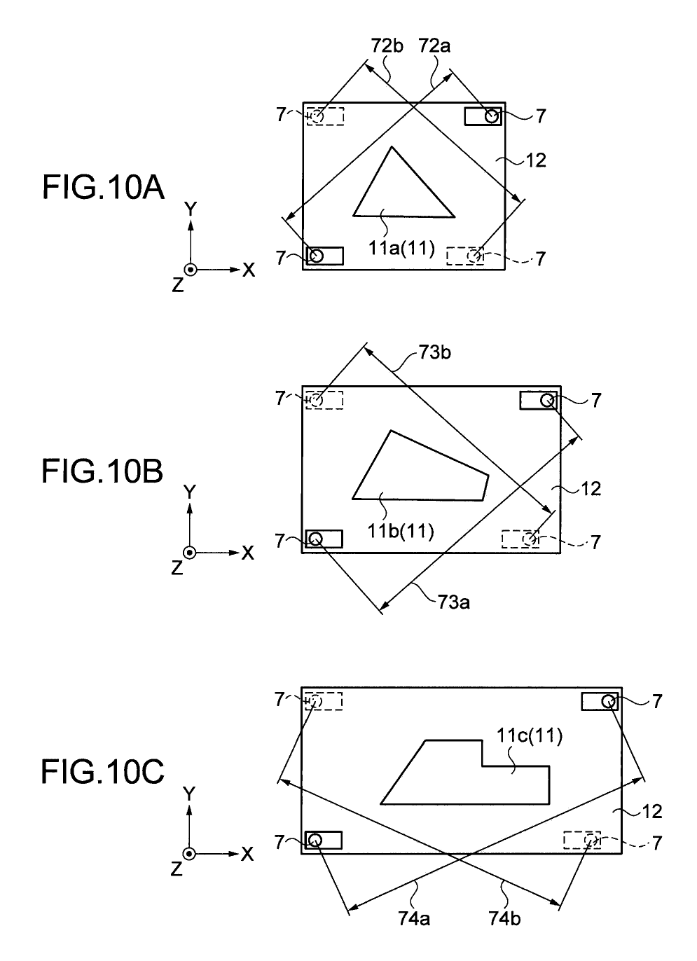

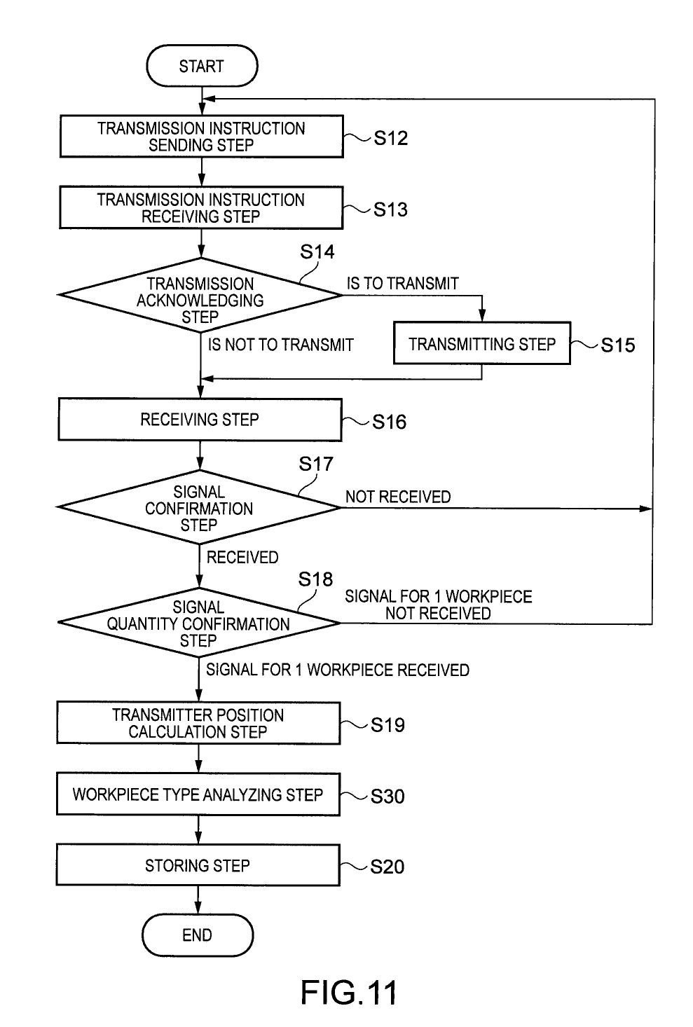

An embodiment of the picking method will now be described using FIGS. 10 through 11 as a second embodiment of the invention. This embodiment differs from the first embodiment in that the ultrasonic wave tags 7 are arranged in different patterns for every type of the workpiece 11. Description of similarities to the first embodiment will not be repeated.

FIGS. 10A through 10C are plan diagrams of the workpieces with the ultrasonic wave tags disposed thereon. In the present embodiment, with reference to FIGS. 10A through 10C, various types of workpieces 11 are used. The layout pattern of the tags 7 disposed on the workpiece supports 12 differs for each workpiece 11. A first workpiece 11a, a second workpiece 11b, and a third workpiece 11c are the workpieces 11 having different configurations. Each workpiece 11 is disposed on the workpiece support 12, and two tags 7 are disposed on front and rear surfaces of each workpiece support 12. A distance between the tags 7 on the front surface of the workpiece support 12 having the first workpiece 11a is a first front tag distance 72a, and a distance between the tags 7 on the rare surface of the workpiece support 12 having the first workpiece 11a is a first rear tag distance 72b.

Similarly, a distance between the tags 7 on the front surface of the workpiece support 12 having the second workpiece 11b is a second front tag distance 73a, and a distance between the tags 7 on the rare surface of the workpiece support 12 having the second workpiece 11b is a second rear tag distance 73b. Also, a distance between the tags 7 on the front surface of the workpiece support 12 having the third workpiece 11c is a third front tag distance 74a, and a distance between the tags 7 on the rare surface of the workpiece support 12 having the third workpiece 11c is a third rear tag distance 74b.

The first front tag distance 72a, the first rear tag distance 72b, the second front tag distance 73a, the second rear tag distance 73b, the third front tag distance 74a, and the third rear tag distance 74b are set to be different from each other. For other types of workpieces 11, also, the pair of ultrasonic wave tags 7 is disposed on each workpiece support 12. The distance between the pair of tags 7 differs for each front and rear surface of each workpiece 11. The distances between the pairs of tags 7 are stored in the memory 44 as the ultrasonic wave tag data 53. Therefore, through detection of the distance between the pair of tags 7, the type of the workpiece 11 and the surface facing the ultrasonic wave receiving devices 15 are recognized. Then, using the distance data between the tags 7, the transmission position calculator 58 retrieves the corresponding workpiece 11 from the workpiece data 55 stored in the memory 44 and thereby confirms the attribute information of the workpiece 11.

FIG. 11 is a flowchart showing the first detection step. Using the flowchart of FIG. 11, the first detection step of step S2 of FIG. 5 will now be described. The steps other than step S2 are the same as those in the first embodiment, and therefore description thereof will not be repeated. Step S2 begins with step S12. Step S12 corresponds to the transmission instruction sending step. In this step, the transmission instruction signal is sent to one of the tags 7 disposed on one workpiece support 12. The step then proceeds to step S13. Steps S13 through S16 are the same as those in the first embodiment, and therefore the descriptions thereof will not be repeated. After step S16 comes to step S17. Step S17 corresponds to the signal confirmation step, which is a step of checking if there is any ultrasonic wave receiving device that has received the waves. If there is no receiving device having received the waves, the step proceeds to step S12. If there is a receiving device having received the waves, the step proceeds to step S18. The steps of steps S18 and S19 are the same as those in the first embodiment, and therefore the descriptions thereof will not be repeated. After step S19 comes to step S30.

Step S30 corresponds to a workpiece type analyzing step. In this step, the distance between the pair of tags 7 disposed on the workpiece support 12 is calculated. Thereafter, the transmission position calculator 58 retrieves the ultrasonic wave tag data 53 stored in the memory 44. Then, the calculator 58 estimates the type of workpiece 11 corresponding to the distance between the tags 7 that sent the waves. Then, in step S20, data of the type, position, and posture of the workpiece 11 is stored in the memory 44. This is the end of the first detection step of step S2.

As described hereinabove, the present embodiment has advantages as below.

1. According to the embodiment, the ultrasonic wave tags 7 are disposed in different layout patterns for each different direction that the workpiece 11 is facing. Therefore, through calculation of the distance between the pair of tags 7, the transmission position calculator 58 can confirm which surface of the workpiece 11 is the surface facing the ultrasonic wave receiving devices 15.

2. According to the embodiment, by detecting the distance between the pair of the ultrasonic wave tags 7, i.e. the transmitters, disposed on each workpiece 11, the type of the workpiece 11 is detected.

The present embodiment is not limited to the embodiments described above, and various modifications and improvements may be made. Modified examples are as follows.

### Modified Example 1

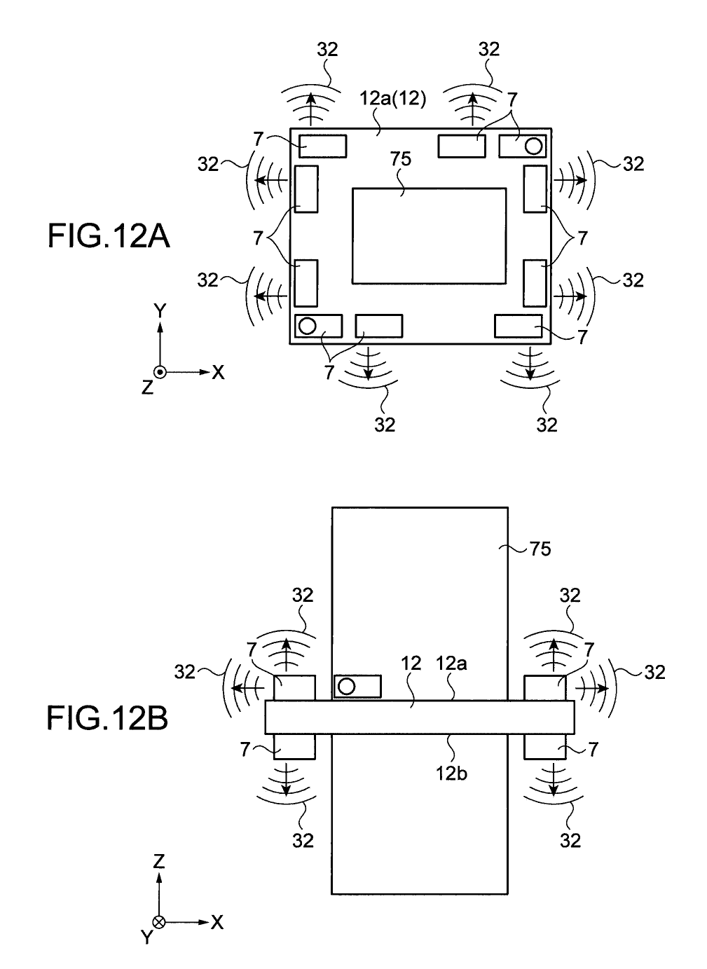

In the first embodiment, the ultrasonic wave tags 7 are disposed on the upper and lower surfaces 12a, 12b of the workpiece 11. The tags 7 may change the directions of sending the ultrasonic waves 32 in accordance with the configuration of the workpiece 11. FIGS. 12A and 12B are pattern diagrams of a workpiece 75. FIG. 12A is a plan pattern diagram showing the workpiece, and FIG. 12B is a side pattern view of the workpiece. Referring to FIGS. 12A and 12B, if the configuration of the workpiece 75 is a rectangular parallelpiped or the like that allows any of its surfaces to face upward, for example, it is possible to dispose the tags 7 in a direction corresponding to the direction of the surface of the workpiece 75 that may face upward. There are five pairs of tags 7 disposed on the upper surface 12a of the workpiece support 12. The waves 32 may be sent in directions of X, opposite from X, Y, opposite from Y, and Z. A pair of tags 7 is disposed on the lower surface 12b of the workpiece support 12. Then, the waves 32 may be sent in a direction opposite from the Z direction. Therefore, the tags 7 disposed on the workpiece support 12 can transmit the waves 32 in six directions, i.e. up, down, front, rear, right, and left. As a result, for every possible posture taken by the workpiece 75, the tags 7 can sent the waves 32 to the ultrasonic wave receiving devices 15.

### Modified Example 2

In the second embodiment, by detecting the distance between the pair of tags 7, the types and the front and rear surfaces of the workpiece 11 are retrieved. There are other methods, however. For example, the plurality of tags 7 may transmit the ultrasonic waves 32 having different frequencies. After the ultrasonic wave receiving devices 15 receive the waves 32, the transmission position calculator 58 may detect the frequencies of the waves 32. In advance, the relationships between the types of the workpieces 11 and the frequencies of the waves 32 sent by the tags 7 are stored in the memory 44 as the ultrasonic wave tag data 53. Then, using the frequencies of the waves 32, the types and the front and rear surfaces of the workpiece 11 may be retrieved. In this method, also, the transmission position calculator 58 identifies the types and postures of the workpieces 11.

### Modified Example 3

In the first embodiment, ultrasonic waves are used to measure the distance between the ultrasonic wave tag 7 and the ultrasonic wave receiving device 15. However, waveforms by other media may be used. For example, laser beams may be used to detect the phase of the laser beam in order to measure the distance. Alternatively, electromagnetic waves may be used to measure the distance. Another method enabling simpler measurement may also be employed. In such a case, also, the types and postures of the workpieces 11 may be detected.

### Modified Example 4

In the first embodiment, the workpiece 11 and the workpiece support 12 are together transferred to the storing device 29. However, only the workpiece 11 may be transferred to the storing device 29, leaving the workpiece support 12 on the belt 9. A detachment mechanism may be disposed on the workpiece support 12. The detachment mechanism may be operated by the hand 28. This may simplify operations in the subsequent steps.

### Modified Example 5

In the first embodiment, the radio wave transmitting device 8 sends the radio wave signal to the tags 7. The radio wave transmitting device 8 may be replaced with an optical transmitting device which carries out an optical communication with the tags 7. This makes it easier to avoid the influence of electromagnetic wave noise.

### Modified Example 6

In the first embodiment, the locations of the tags 7 are calculated from the waves 32 transmitted from three ultrasonic wave receiving devices 15. Also, four receiving devices 15 may be disposed per each receiving region 40. The locations of the tags 7 are then calculated from the waves 32 that the four ultrasonic wave receiving devices 15 received. JP-A-6-222130 discloses a method for calculating the location of an ultrasonic wave source using one ultrasonic wave source and four receiving devices. This is a method in which four equations are formed concerning the distances between the ultrasonic wave source and the four receiving devices. The location of the wave source is then calculated by computing the solutions to the equations. Since this method does not require transmission timing signals sent from the radio wave transmitting device 8, the circuitry composition may be simplified.

### Modified Example 7

In the first embodiment, whether or not the ultrasonic waves 32 sent from the second ultrasonic wave tag 7b have been received is determined in the signal quantity confirmation step of step S18. If not received, the radio wave signal 64 is transmitted in the transmission instruction sending step of step S12. After receiving the radio wave signal 64, the second tag 7b sends the waves 32. However, other procedures may apply. The second tag 7b may send the waves 32 after a predetermined time has passed since the first tag 7a sent the waves 32. Since this procedure is simpler, the program software 52 may be simplified. As a result, the program software 52 may be productively manufactured.

### Modified Example 8

In the first embodiment, the workpieces 11 are transferred using the conveyer 2. There may be other methods of transferring the workpieces 11. The requirement here is that the workpieces 11 move on a predetermined course. For example, a self-propelled device may be provided to each workpiece support 12.

### Modified Example 9

In the first embodiment, each workpiece 11 advances straightforward by the belt 9 of the conveyer 2. However, the workpiece 11 may be transferred differently. The workpiece 11 may draw a curve by the belt 9. Alternatively, the workpiece 11 in motion may make a curve having a predetermined angle. In this case, if the movement locus of the workpiece 11 is estimated in advance, the simulation operator 60 may also simulate the operations of the workpiece 11 and the robot 4.

### Modified Example 10

In the first embodiment, in the second transfer step of step S7, the robot 4 grabs the workpiece 11 while the workpiece 11 is being transferred by the belt 9. However, the belt 9 may be stopped when the robot 4 grabs the workpiece 11. This makes it possible for the robot 4 to more readily grab the workpiece 11.

### Modified Example 11

In the first embodiment, in the second detection step of step S5, the image processor 49 analyzes the image 68 picked up by the imaging device 17 and analyzes the posture of the workpiece 11. However, if it is possible that the robot 4 grabs the workpiece 11 using the position data of the ultrasonic wave tags 7 detected by the ultrasonic wave receiving devices 15, the step S15 may be skipped. Because the imaging device 17, the image processor 49, and the like may not be used, the picking apparatus 1 may be simplified.

### Modified Example 12

In the first embodiment, the ultrasonic wave tags 7 are not disposed on the arms and joints of the robot 4. However, the tags 7 may also be disposed on the hand 28, arms, and joints of the robot 4. The positions of the hand 28, arms, and joints of the robot 4 are then detected using the receiving devices 15. Using the position data, the movement of the hand 28 up to when it grabs the workpiece 11 may be simulated. Because the position of each part of the robot 4 may be identified with high accuracy, the movement of the hand 28 may be simulated accurately.

### Modified Example 13

In the first embodiment, the waves are sent from the tags 7 directly to the ultrasonic wave receiving devices 15. However, the tags 7 may be installed such that the waves 32 may pass through the workpiece 11 before reaching to the receiving devices 15. When the waves 32 pass through the workpiece 11, the speed of advance changes depending on the composition of the workpiece 11. Accordingly, by detecting the phase of the waves 32 sent to the receiving devices 15, the composition of the workpiece 11 may be analyzed.

### Modified Example 14

In the first embodiment, the waves 32 are sent from the tags 7 directly to the receiving devices 15. However, there is a case in which the workpiece 11 become an obstacle, and the waves 32 are not transmitted from the tags 7 directly to the receiving devices 15. In this case, the tags 7 may transmit the waves 32 to the workpiece 11, and the waves 32 reflected by the workpiece 11 may be sent to the receiving devices 15. Even if the workpiece 11 becomes the obstacle, the distance between the tags 7 and the receiving devices 15 may be measured using the waves 32.

### Modified Example 15

In the first embodiment, the number of the tags 7 disposed on the workpiece support 12 is fixed. However, the number of the tags disposed on the workpiece support 12 may be changed by adding or eliminating the tags 7 to/from the workpiece support 12. For example, depending on progress of work conducted to the workpiece 11, the number of the tags 7 to be disposed may vary. It therefore becomes possible to distinguish the status of each workpiece 11.

### Modified Example 16

In the first embodiment, the distance between the tags 7 and the receiving devices 15 is measured using the time between sending of the waves 32 from the tags 7 and reaching to the receiving devices 15. However, other methods may apply. For example, the distance between the tags 7 and the receiving devices 15 may be measured using an increase or decrease in the strength of waves 32 reaching to the receiving devices 15. The same method may also apply when using electromagnetic waves or optical beams instead of ultrasonic waves 32. The method of detecting the strength simplifies the measurement circuit compared to the method of measuring time.

### Modified Example 17

In the first embodiment, the waves 32 are transmitted from the tags 7 to the receiving devices 15 while avoiding interruption from the workpiece 11. If there is a step of removing a portion of the workpiece 11, the tags 7 may be arranged so that the portion to be removed interrupts the waves 32. Because the waves 32 are not interrupted after removing the portion of the workpiece 11, the transmission position calculator 58 may detect that the portion of the workpiece 11 has been removed. Thus, the transmission position calculator 58 may detect the progress of work conducted on the workpiece 11.

This application claims the benefit of Japanese Patent Application No. 2008-275248 filed Oct. 27, 2008. The disclosures of the above application are incorporated herein by reference.

What is claimed is:

1. A workpiece detection system, comprising:
a plurality of transmitters disposed on a workpiece, each transmitter transmitting a first signal;
three or more receivers receiving the first signal transmitted from the transmitter; and
a position calculator detecting a location of the transmitter based on the first signal received by each of the receivers, wherein
the position calculator detects a posture of the workpiece from information on the detected locations of the plurality of transmitters.

2. The workpiece detection system according to claim 1, wherein:
there are a plurality of types of workpieces and a distance between the transmitters provided to the workpieces is different for each type of the workpiece.

3. The workpiece detection system according to claim 2, further comprising:
an attribute storing unit storing a relationship between the distance between the transmitters and the workpiece, wherein
the position calculator detects attribute information of the workpiece using data of the distance between the transmitters.

4. The workpiece detection system according to claim 3, wherein:
the transmitter is an ultrasonic wave tag that transmits ultrasonic waves; and
the receiver receives the ultrasonic waves.

5. The workpiece detection system according to claim 4, wherein:
the plurality of transmitters are disposed such that the transmitters transmit the signals in different directions.

6. The workpiece detection system according to claim 5, wherein:
the plurality of transmitters facing different directions are disposed in different layout patterns.

7. The workpiece detection system according to claim 6, wherein:
the workpiece includes a transmitter support member; and
the transmitter is disposed on the transmitter support member.

8. The workpiece detection system according to claim 7, wherein the workpiece includes:
a start transmission signal receiving part; and
a start transmission signal sender that transmits a start transmission signal to the start transmission signal receiving part, and wherein
the transmitter sends the first signal after the start transmission signal receiving part receives the start transmission signal.

9. The workpiece detection system according to claim 8, wherein:
the start transmission signal sender sends the start transmission signal including a predetermined code;
the start transmission signal receiving part receives the start transmission signal; and
the transmitter sends the first signal only if the predetermined code corresponds with a preset code.

10. The workpiece detection system according to claim 7, wherein:
some of the transmitters transmit the first signals having waveforms of different frequencies; and
after the receivers receive the first signals, the position calculator detects the waveform frequencies of the first signals.

11. The workpiece detection system according to claim 10, wherein:
the receivers are disposed at substantially equal intervals with respect to a moving direction of the workpiece;
the disposed receivers are sequentially arranged in numbers of one, two, one, two; and
at least three receivers receive the first signal transmitted from one of the transmitters during movement of the workpiece.

12. A picking apparatus, comprising:
the workpiece detecting system according to claim 1;
a workpiece transfer unit that transfers the workpiece; and
a robot that grabs and transfers the workpiece to a predetermined location.

13. The picking apparatus according to claim 12, further comprising:
an imaging device; and
an image calculator that detects position and configuration of the workpiece using an image picked up by the imaging device, wherein
the image calculator inputs position information of the workpiece from the position calculator, specifies a location in the image where the workpiece is imaged, and analyzes the specified location.

14. The picking apparatus according to claim 13, wherein:
the transmitters are disposed on the robot and on a workpiece transfer unit at fixed positions against the robot.

15. A picking method, comprising:
transferring a workpiece by a workpiece transfer unit as a first transfer step;
transmitting an ultrasonic wave signal from each of a plurality of transmitters disposed on the workpiece and detecting a posture of the workpiece using a receiver as a first detection step; and
grabbing and transferring the workpiece by a robot as a second transfer step, wherein
a posture of the workpiece is detected based on a time of arrival of the ultrasonic wave signal to each of the plurality of receivers, the signal being transmitted from each transmitter in the first detecting step.

16. The picking method according to claim 15, further comprising:
detecting a location of the workpiece in the first detection step;
picking up an image of the workpiece using an imaging device and detecting the location and the posture of the workpiece by analyzing the picked up image as a second detection step which is carried out between the first detection step and the second transfer step; and
analyzing, in the second detection step, a portion of the image using information on the location of the workpiece that is detected in the first detection step.

17. A transfer system, comprising:
a first transport unit;
a second transport unit;
a robot;
a workpiece that is placed on the first transport unit and includes a plurality of transmitters transmitting signals; and
three or more receivers,
wherein: the receivers receive the signals transmitted by the transmitters, and detect locations of the transmitters using times of arrival of the signals received by the receivers; a posture of the workpiece is detected from information on the locations of the transmitters; and the robot grabs the workpiece and places the workpiece on the second transport unit.
